(19) United States
(12) Patent Application Publication
(10) Pub. No.: US 2007/0052392 A1
(43) Pub. Date: Mar. 8, 2007

(54) METHOD AND APPARATUS FOR TRICKLE-CHARGING BATTERIES

(76) Inventor: Elliott Galynsky, Woodland Hills, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/162,375

(22) Filed: Sep. 8, 2005

(51) Int. Cl. H02J 7/00

(52) U.S. Cl. 320/131

(57) ABSTRACT

The car battery trickle charger comprising a power converter, an extension cord, a storage coil, a universal coupling, and a battery connection. The storage coil includes a spring-loaded winding mechanism and a releasable lock. The universal coupling permits interchange of various configurations of battery connections including positive and negative terminal clamps, positive and negative terminal loops, or a power point adapter.

### BACKGROUND OF THE INVENTION

The present invention generally relates to trickle chargers for car batteries. More particularly, the present invention relates to a car battery trickle charger that is connectable to varying power sources and has a universal adapter capable of accommodating multiple battery connection configurations.

Car battery trickle chargers are known in the prior art. See for example, U.S. Pat. Nos. 4,404,513; 4,417,195; and 4,672,295. These and other prior art devices typically include only one configuration for a battery connection. The extension cord and battery configuration in these prior art devices are permanently connected and may not be altered without mechanically cutting the wires.

Such prior art devices typically consist of a long extension cord having sufficient length to reach from an electrical source to the car battery. In most cases, a car battery cannot be brought sufficiently close to an electrical source without either removing the battery from the automobile or having an extension cord of sufficient length. For convenience, most prior art car battery charging devices are manufactured having a very long extension cord in order to be operable in those instances where the electrical source distant from the car battery. In those cases where the electrical source is relatively close to the car battery, the extra long extension cord becomes unwieldy and may pose a hazard.

Accordingly, there is a need for an apparatus which enables a user of a car battery trickle charger to use interchangeable battery connections and have an extension cord of variable length. The present invention fulfills these needs and provides other related advantages.

### SUMMARY OF THE INVENTION

The car battery trickle charger of the present invention comprises a power converter connectable to an electrical source, an extension cord electrically connected to the power converter, a storage coil capable of storing the extension cord, a universal coupling having first and second coupling halves, one of said halves electrically connected to the extension cord, and a battery connection electrically connected to the other coupling half. The car battery trickle charger is configurable to be connected to an AC or a DC electrical source. The storage coil of the present invention may include a housing and a spring-loaded winding mechanism that has a releasable lock. The spring-loaded winding mechanism is configured to draw substantially all of the length of the extension cord into the storage coil. When a user draws the extension cord out of the storage coil, the releasable lock engages and prevents the spring-loaded winding mechanism from drawing the extension cord back into the storage coil. A user may then disengage the releasable lock with a quick tug which will then cause the spring-loaded winding mechanism to draw the extension cord into the storage coil. The housing completely encases the spring-loaded winding mechanism, releasable lock and the length of extension cord presently drawn into the storage coil. The power converter may be enclosed within the housing or may comprise a separate unit located external of the housing. The battery connection may comprise positive and negative terminal clamps, positive and negative terminal loops, or a power point adapter.

### DESCRIPTION OF THE DRAWINGS

The accompanying drawings illustrate the invention. In such drawings:

FIG. 1 is a depiction of the car battery trickle charger embodying the present invention, connected to an electrical source and a car battery;

FIG. 2 is a depiction of the car battery trickle charger embodying the present invention;

FIG. 3 is a depiction of the car battery trickle charger embodying the present invention;

FIG. 4 is a depiction of the car battery trickle charger embodying the present invention;

FIG. 5 is close up view of the universal coupling of the present invention, wherein the first and second coupling halves are connected;

FIG. 6 is a depiction of the universal coupling of the present invention, wherein the first and second coupling halves are separated;

FIG. 7 is a depiction of a battery connection and second coupling half of the present invention, wherein the battery connection comprises positive and negative terminal clamps;

FIG. 8 is a battery connection and second coupling half of the present invention, wherein the battery connection comprises positive and negative terminal loops; and

FIG. 9 depicts the battery connection and second coupling half of the present invention, wherein the battery connection comprises a power point adapter.

### DETAILED DESCRIPTION OF THE PREFERRED EMBODIMENTS

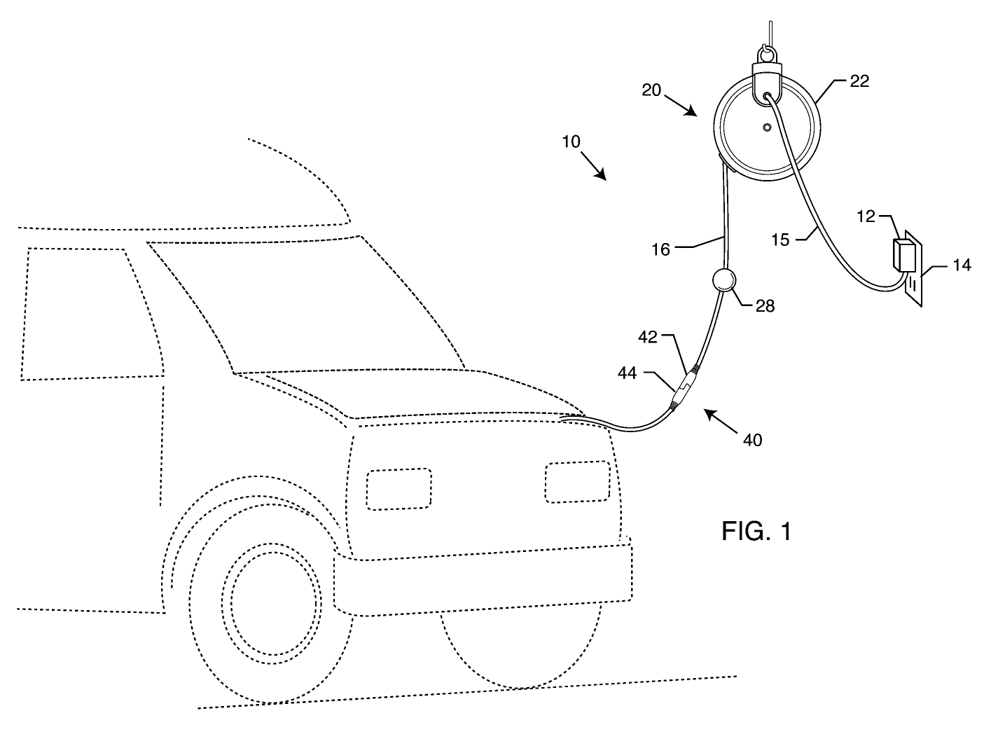

As shown in the accompanying drawings, for purpose of illustration, the present invention resides in a car battery trickle charger, generally referred to by the reference number 10. As illustrated in FIG. 1 the trickle charger 10 is designed to connect to an electrical source 14, at one end, and a car battery (not shown), at the other end.

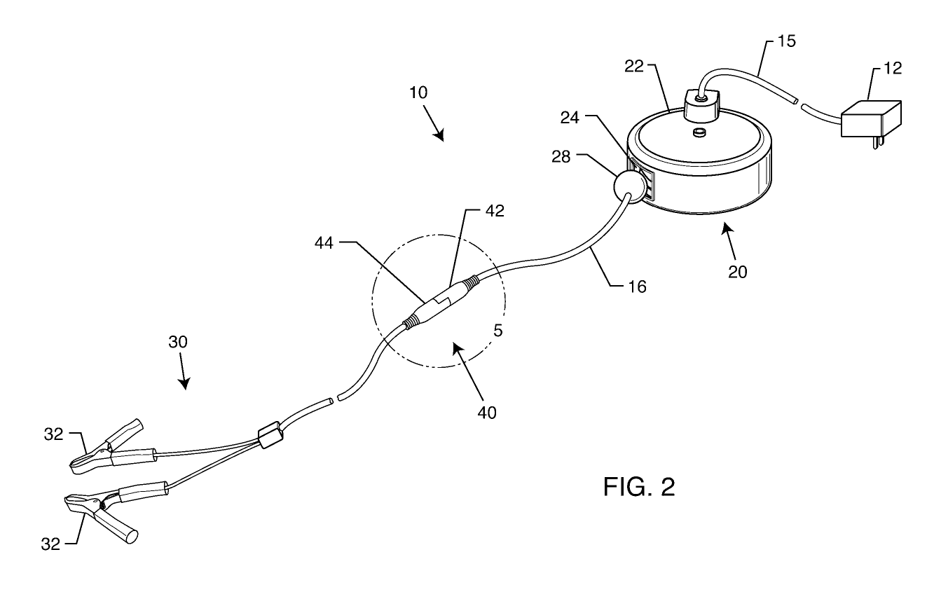

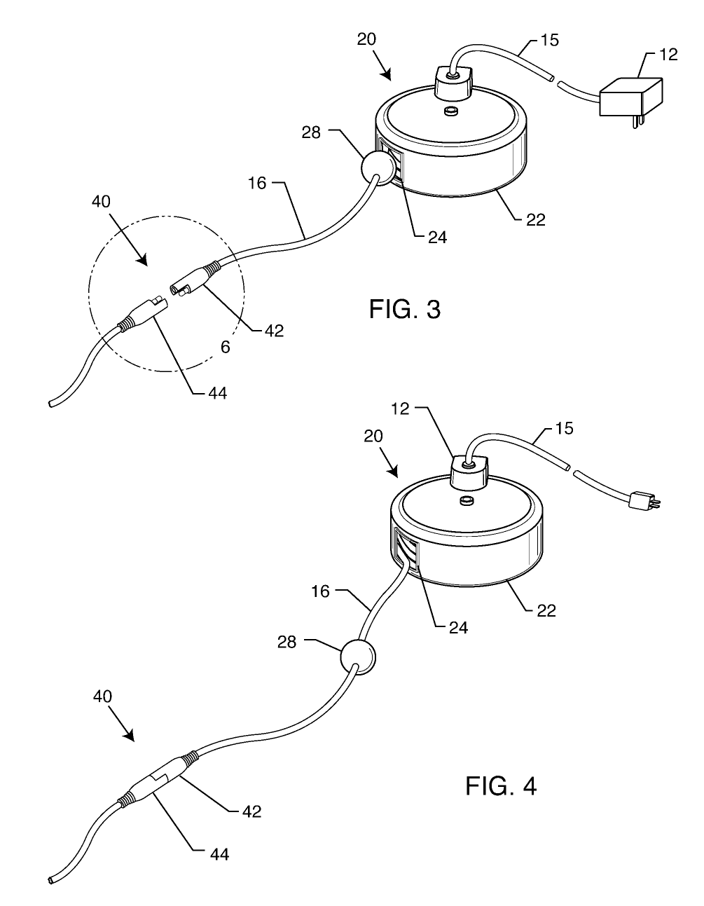

With references to FIGS. 2, 3 and 4, the trickle charger 10 is generally comprised of a power converter 12, an extension cord 16, a storage coil 20, a universal coupling 40 and a battery connection 30. As illustrated in FIGS. 3 and 4, the extension cord 16 is adapted to be removeably stored within the storage coil 20. FIG. 3 depicts the extension cord 16 completely wound onto the storage coil 20. FIG. 4 depicts the extension cord 16 partially unwound from the storage coil 20.

The storage coil 20 may be hand wound so that the extension cord 16 may be conveniently stored. In an alternate embodiment, the storage coil 20 may include a housing 22, a spring-loaded winding mechanism (not shown) and a releasable lock (not shown). Such spring-loaded winding mechanism and a releasable lock are well-known in the art. The spring-loaded winding mechanism automatically winds the extension cord 16 onto the storage coil 20 inside the housing 22. An opening 24 in the housing 22 permits the extension cord 16 to be wound onto the storage coil 20 through the housing 22.

The power converter 12 may be configured to connect to an electrical source 14 and may comprise an electrical connection 15 to the extension cord 16 through the storage coil 20, as depicted in FIG. 3. In an alternate embodiment, as depicted in FIG. 4, the power converter 12 may be contained within the housing 22 of the storage coil 20 and may comprise an electrical connection 15 to the power source 14.

In operation, a user may pull the extension cord 16 off of the storage coil 20 against the force of the spring-loaded winding mechanism. When the user ceases pulling on the extension cord 16, the releasable lock engages preventing the spring-loaded winding mechanism from automatically winding the extension cord 16 back onto the storage coil 20. The user may then release the releasable lock by giving a quick tug on the extension cord 16, thereby permitting the spring-loaded winding mechanism to wind the extension cord 16 onto the storage coil 20. A stop ball 28 having a diameter greater than a dimension of the opening 24 prevents the extension cord 16 from being completely drawn onto the storage coil 20 into the housing 22.

The universal coupling 40 includes first and second coupling halves 42, 44 which are mechanically and electrically connectable and separable. The first coupling half 42 is electrically connected to the extension cord 16. The second coupling half 44 is interchangeable with structurally similar second coupling halves 44 having other configurations for battery connection 30. The available configurations for battery connections 30 include positive and negative terminal clamps 32, positive and negative terminal loops 34, and a power point adapter 36.

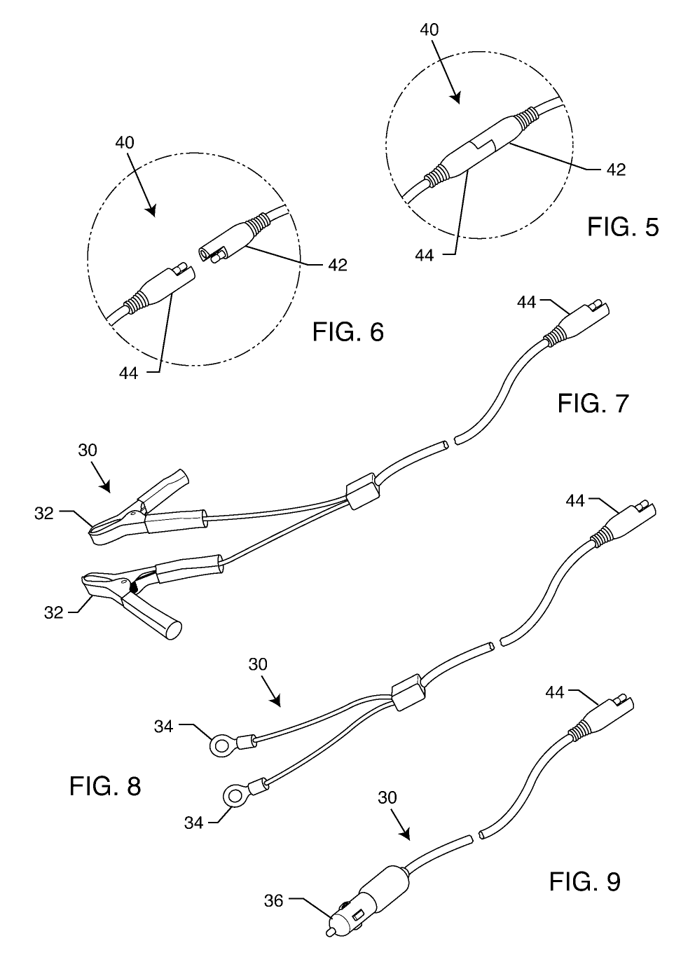

FIGS. 5 and 6 present close up views of the universal coupling 40. The first coupling half 42 and second coupling half 44 are configured to be connected in only one orientation. This configuration assures that positive wires are only connected to positive wires and negative wires are only connected to negative wires. FIGS. 7, 8 and 9 depict the different configurations for the battery connection 30. The positive and negative terminal clamps 32, positive and negative terminal loops 34 and power point adapter 36 are interchangeable for connecting the trickle charger 10 to a car battery. Each of the available battery connections 30 are well-known in the art. The power point adapter 36 is connectable to any available power point in an automobile. Such power points are common in automobiles today and may include a standard cigarette lighter port.

Although various embodiments have been described in detail for purposes of illustration, modifications may be made without departing from the scope and spirit of the invention.

What is claimed is:

1. A car battery trickle charger, comprising:
a power converter connectable to an electrical source;
an extension cord electrically connected to the power converter;
a storage coil capable of storing the extension cord, the storage coil including a housing and a spring-loaded winding mechanism having a releasable lock;
a universal coupling having first and second coupling halves, wherein the first coupling half is electrically connected to the extension cord and the second coupling half is electrically connected to the first coupling half; and
a battery connection electrically connected to the second coupling half.

2. The trickle charger of claim 1, wherein the electrical source is an AC electrical source.

3. The trickle charger of claim 1, wherein the electrical source is a DC electrical source.

4. The trickle charger of claim 1, wherein the power converter is contained within the housing.

5. The trickle charger of claim 1, wherein the battery connection comprises positive and negative terminal clamps, positive and negative terminal loops, or a power point adapter.

6. A car battery trickle charger, comprising:
a power converter connectable to an electrical source;
an extension cord electrically connected to the power converter;
a storage coil capable of storing the extension cord, the storage coil including a housing and a spring loaded winding mechanism;
a universal coupling having first and second coupling halves, wherein the first coupling half is electrically connected to the extension cord and the second coupling half is electrically connected to the first coupling half; and
a battery connection electrically connected to the second coupling half, wherein the battery connection comprises positive and negative terminal clamps, positive and negative terminal loops, or a power point adapter.

7. The trickle charger of claim 6, wherein the spring loaded winding mechanism includes a releasable lock.

8. The trickle charger of claim 6, wherein the power converter is contained within the housing.

9. The trickle charger of claim 8, wherein the electrical source is an AC electrical source.

10. The trickle charger of claim 8, wherein the electrical source is a DC electrical source.

11. A car battery trickle charger, comprising:
a power converter connectable to an electrical source;
an extension cord electrically connected to the power converter;
a storage coil capable of storing the extension cord, the storage coil including a housing and a spring loaded winding mechanism having a releasable lock, wherein the power converter is contained with the housing;
a universal coupling having first and second coupling halves, wherein the first coupling half is electrically connected to the extension cord and the second coupling half is electrically connected to the first coupling half; and
a battery connection electrically connected to the second coupling half, wherein the battery connection comprises positive and negative terminal clamps, positive and negative terminal loops, or a power point adapter.

12. The trickle charger of claim 11, wherein the electrical source is an AC electrical source.

13. The trickle charger of claim 11, wherein the electrical source is a DC electrical source.
